(19) United States
(12) Patent Application Publication
(10) Pub. No.: US 2026/0128247 A1
(43) Pub. Date: May 7, 2026

(54) COMBINED LEAKAGE PROTECTION DEVICE

(71) Applicant: Chengli LI, Suzhou (CN)

(72) Inventors: Chengli LI, Suzhou (CN); Hao TIAN, Suzhou (CN); Xiaoming ZHANG, Suzhou (CN)

(73) Assignee: Chengli LI, Suzhou (CN)

(21) Appl. No.: 18/941,159

(22) Filed: Nov. 8, 2024

(30) Foreign Application Priority Data
Nov. 6, 2024 (CN) 202411572494.0

(51) Int. Cl. H01H 71/02; H01H 71/10; H02H 3/16

(52) U.S. Cl. CPC H01H 71/02; H01H 71/10; H02H 3/16

(57) ABSTRACT

A combined leakage protection device is provided. The combined leakage protection device includes: an input end, an output end, a circuit breaker module and a ground fault circuit interrupter module. The ground fault circuit interrupter module includes a housing, and a ground fault signal processing unit, a drive assembly and a locking device disposed inside the housing. The locking device is attached to the circuit breaker module and has a locked state and an unlocked state. The locking device can be mechanically linked to the drive assembly to switch between the locked state and the unlocked state. The combined leakage protection device can effectively provide power-off protection in the event of a leakage fault through the cooperation of the locking device and the drive assembly, and is suitable for a variety of electrical equipment to improve safety of use.

### BACKGROUND OF THE INVENTION

This invention generally relates to the field of leakage protection devices, and in particular, it relates to a combined leakage protection device with ground fault protection function and circuit breaker protection function.

With the improvement of living standards and people's safety awareness, electrical devices with leakage protection function are becoming more and more widely used. Traditional circuit breakers cannot achieve power-off protection in the event of leakage, which brings the risk of electric shock to users and hidden dangers of electricity safety. To further protect personal safety and reduce the occurrence of electric shock hazards in the event of leakage, leakage protection devices are provided. The leakage protection device is a grounding protection device used to prevent accidents caused by electric shock and leakage. When a leakage fault occurs, it can cut off the power in time to protect personal and equipment safety.

Conventional leakage protection devices on the market, such as ground fault circuit interrupters (GFCIs), are mainly used for protection of small current devices such as 20 amps or less in household applications. There are demands from manufacturers and consumers for improved leakage protection devices so that they can be used in various applications such as high current scenarios according to different needs.

### SUMMARY OF THE INVENTION

Based on these needs, embodiments of the present invention provide a leakage protection device to meet different application scenarios in a cost-effective and reliable manner.

Accordingly, an embodiment of the present invention provides a combined leakage protection device, which includes: an input end, configured to be coupled to a power supply; an output end, configured to be coupled to an electrical load; a circuit breaker module, and a ground fault circuit interrupter module. The circuit breaker module has a disconnected state and a connected state, which respectively disconnects and connects an electrical connection between the input end and the output end. The ground fault circuit interrupter module includes a housing, and a ground fault signal processing unit and a drive assembly and a locking device couple to the ground fault signal processing unit disposed inside the housing. The drive assembly is in a first position or a second position under control of the ground fault signal processing unit. The locking device is attached to the circuit breaker module and has a locked state and an unlocked state; the locking device is mechanically linked to the drive assembly to switch between the locked state and the unlocked state.

Based on the above technical characteristics, the present invention may include any one or more of the embodiments below.

In some embodiments, the locking device includes a drive plate assembly and locking rod attached to the circuit breaker module. In some embodiments, the drive plate assembly includes a driving plate and a locking plate. In some embodiments, the driving plate is attached to the circuit breaker module and mechanically linked to the circuit breaker module to define a first position and a second position of the driving plate; and wherein the locking plate is attached to the driving plate and is moveable relative to the driving plate between a first position and a second position of the locking plate. In some embodiments, when the locking plate is at its first position relative to the driving plate, the drive plate assembly and the locking rod are in a locked state and the locking rod is driven by the drive plate assembly; and when the locking plate is at its second position relative to the driving plate, the drive plate assembly and the locking rod are in an unlocked state and the locking rod is independently moveable relative to the drive plate assembly. In some embodiments, the drive plate assembly further includes a resilient member disposed between the driving plate and the locking plate and configured to urge the locking plate to return from its second position to its first position. In some embodiments, the resilient member is a torsion spring which has a resilient winding, a first torsion spring leg and a second torsion spring leg. In some embodiments, the driving plate has a main body which is a fan-shaped panel, and a pin formed on one side of the fan-shaped panel, wherein the driving plate is attached to the circuit breaker module via the pin. In some embodiments, the fan-shaped panel of the driving plate defines a pivot hole and a position limiting slot. In some embodiments, the position limiting slot defines a position limiting block on its side wall. In some embodiments, the driving plate further includes a torsion spring hole buckle and a torsion spring leg buckle, wherein the resilient winding of the torsion spring is snapped onto the torsion spring hole buckle and the first torsion spring leg is snapped onto and fixed with the torsion spring leg buckle. In some embodiments, the locking plate includes a snap-fit end face which abuts against the second torsion spring leg of the torsion spring. In some embodiments, the locking plate is attached to the driving plate, and wherein the locking plate includes a pivot at one end and is configured to pivot relative to the driving plate. In some embodiments, the locking plate further includes a position limiting post configured to limit a movement range of the locking plate on the driving plate. In some embodiments, the position limiting post includes a position limiting hook configured to prevent separation of the locking plate and the driving plate. In some embodiments, the locking plate further includes a locking protrusion configured to drive the locking rod to move. In some embodiments, the drive assembly is configured to drive the locking plate to move from its first position to its second position. In some embodiments, the locking rod has a pivot hole, which is attached to the housing to allow the locking rod to pivot relative to the housing. In some embodiments, the locking rod has a locking notch, wherein the drive plate assembly is configured to drive the locking rod by engaging the locking notch.

In some embodiment, the ground fault circuit interrupter module further includes an auxiliary switch coupled to the ground fault signal processing unit, wherein the auxiliary switch is mechanically linked to and moves with the locking device to be in an open state or a closed state. In some embodiment, the auxiliary switch includes a resilient driving arm configured to contact the locking device. In some embodiment, when the locking device is in the unlocked state, the auxiliary switch is in the open state. In some embodiment, when the locking device is in the locked state and the circuit breaker module is in the closed state, the auxiliary switch is in the closed state.

In some embodiments, the drive assembly includes: an actuator, configured to drive the locking device to an unlocked state; and a coil assembly, attached to the actuator, and configured to control movement of the actuator in response to the ground fault signal processing unit. In some embodiments, the coil assembly includes a coil winding, an iron core, and an iron core spring. In some embodiments, the actuator is configured to drive the circuit breaker module to the disconnected state. In some embodiments, the actuator has a pivot hole attached to the housing, wherein the actuator is configured to pivot relative to the housing. In some embodiments, the coil winding has a center hole configured to accommodate the iron core spring and the iron core. In some embodiments, the coil winding drives the iron core to reciprocate in the center hole in response to the ground fault signal processing unit. In some embodiments, the iron core has an iron core groove, configured to engage with the actuator to drive the actuator to move.

In some embodiments, the housing of the ground fault circuit interrupter module includes upper cover and a base, which form a cavity to accommodate the ground fault signal detection unit and the drive assembly coupled to the ground fault signal detection unit. In some embodiments, the ground fault signal processing unit includes a detection magnetic ring configured to detect a ground fault signal in an electrical circuit passing through the detection magnetic ring; and wherein the housing has a through hole concentric with an inner hole of the detection magnetic ring. In some embodiments, the housing further includes a cover plate, which is snapped on the upper cover and form a housing space with the upper cover, wherein the housing space accommodates at least a part of the drive assembly or the locking device. In some embodiments, the cover plate has an opening in a middle part to allow the ground fault circuit interrupter module to be attached to and mechanically linked with the circuit breaker module. In some embodiments, the housing includes a test button hole, wherein the ground fault signal processing unit includes a test button; and wherein a portion of the test button passes through the housing via the test button hole. In some embodiments, the housing includes a reset button hole, wherein the ground fault signal processing unit includes a reset button; and wherein a portion of the reset button passes through the housing via the reset button hole. In some embodiments, the housing includes a display hole, wherein the ground fault signal processing unit includes a display unit; and wherein a display signal of the display unit passes through the housing via the display hole.

In some embodiments, the combined leakage protection device further includes a fixing device configured to connect the circuit breaker module and the ground fault circuit interrupter module to each other. In some embodiments, the fixing device includes at least one of a rivet, a screw, and a snap.

The combined leakage protection device according to embodiments of the present invention can effectively provide power-off protection in cases of leakage faults by integrating a circuit breaker module and a ground fault circuit interrupter module, and through the cooperation of a locking device and a drive assembly. It is suitable for a variety of electrical equipment to improve the safety of use. The combined leakage protection device has a simple structure, low cost, easy implementation, reliable performance, is suitable for automated production, and can be applied to various occasions.

### BRIEF DESCRIPTION OF DRAWINGS

Other features and advantages of the present invention may be understood from the embodiments described below with reference to the drawings.

FIGS. 1A and 1B are exterior views from different viewing angles of a combined leakage protection device according to an embodiment of the present invention.

FIGS. 2A and 2B are exploded views from different viewing angles of a circuit breaker module and a ground fault circuit interrupter module of the combined leakage protection device, showing the assembly relationship of the circuit breaker module, a locking device, an actuator, a cover plate and other components of the ground fault circuit interrupter module.

FIGS. 3A and 3B illustrate the contact surfaces between the circuit breaker module and the ground fault circuit interrupter module in the combined leakage protection device.

FIG. 4A is an exploded view showing a drive plate assembly of the locking device assembled on an operating handle of the circuit breaker module.

FIG. 4B is an exploded view of the drive plate assembly and the operating handle.

FIGS. 5A and 5B are exploded views from different viewing angles of the drive plate assembly, showing detailed features of a drive plate, a locking plate and a torsion spring.

FIG. 6A illustrates the overall appearance of the ground fault circuit interrupter module.

FIGS. 6B and 6C are exploded views from different viewing angles of the ground fault circuit interrupter module.

FIG. 7A illustrates the actuator.

FIG. 7B illustrates a locking rod of the locking device.

FIG. 7C is an exploded view of a coil assembly of the driving assembly.

FIG. 8A illustrates the circuit breaker module in a state where the operating handle and a circuit breaker tripping rod are located at their first positions, the driving assembly and the locking device are both located at their first positions, the locking device is in a locked state, and the locking plate in the locking device is located at its first position.

FIG. 8B illustrates the circuit breaker module in a state where the operating handle and the circuit breaker tripping rod move from the first positions to their second positions, and in that process, the operating handle drives the locking device, and drives the auxiliary switch to close, when and the input end and the output end are not yet connected.

FIG. 8C illustrates the circuit breaker module in a state where the operating handle and the circuit breaker tripping rod are moved to their second positions, the auxiliary switch remains in a closed state, and the input end and the output end are connected.

FIG. 9A illustrates the circuit breaker module in a state where the operating handle is in the second position and the input end is connected to the output end, and the ground fault circuit interrupter module detects a ground fault signal or a simulated ground fault signal, and controls the drive assembly to operate, so that the actuator drives the circuit breaker tripping rod to its first position and drives the locking device to be unlocked.

FIG. 9B illustrates the circuit breaker module in a state where, after a ground fault signal or a simulated ground fault signal is detected and the circuit breaker trips, but before the ground fault is eliminated or the reset button is pressed and the operating handle is moved from the first position to the second position again, the auxiliary switch is closed first, the ground fault circuit interrupter module controls the drive assembly to operate, the actuator drives the circuit breaker tripping rod to its first position, and drives the locking device to be unlocked. In this process, even if the operating handle is moved to the second position, the input end and the output end will not be connected.

FIG. 9C illustrates the circuit breaker module in a state where the operating handle is in the second position or cannot be returned to the first position due to special reasons, the ground fault circuit interrupter module detects a ground fault signal or a simulated ground fault signal and controls the drive assembly to operate, the actuator drives the circuit breaker tripping rod to its first position, and drives the locking device to be unlocked, and the auxiliary switch is disconnected.

FIG. 10A is an exterior view of a combined leakage protection device with a two-pole circuit breaker module according to another embodiment of the present invention.

FIG. 10B is an exterior view of a combined leakage protection device with a three-pole circuit breaker module according to another embodiment of the present invention.

### DETAILED DESCRIPTION OF THE INVENTION

Preferred embodiments of the present and their applications are described below. It should be understood that these descriptions describe embodiments of the present invention but do not limit the scope of the invention. When describing the various components, directional terms such as “up,” “down,” “top,” “bottom” etc. are not absolute but are relative. These terms may correspond to the views in the various illustrations, and can change when the views or the relative positions of the components change.

In the descriptions below, terms such as “comprising”, “including”, “containing”, “having”, etc. are intended to be open-ended and do not exclude elements, step or components not specifically listed.

In this disclosure, unless otherwise indicated, terms such as “mount”, “connect”, “couple”, “link” etc. should be understood broadly; for example, they may be fixed connections, or removable or detachable connections, or integrally connected for integrally formed; they may be directly connected, or indirectly connected via intermediate parts, and may refer to internal connection of two components or mutual interactions of two components. Those skilled in the relevant art can readily understand the meaning of these terms as used in this disclosure based on the specific description and context.

In this disclosure, ordinal numbers such as first, second, etc. do not connote a temporal or spatial sequence or a particular number of parts.

Traditional circuit breakers cannot provide power-off protection in the event of leakage, and existing leakage protection devices have limited application scenarios. In order to meet the more diversified needs of consumers, such as the need for electrical devices to be suitable for various application scenarios such as high current scenarios, embodiments of the present invention provide a combined leakage protection device that combines the circuit breaker and ground fault protection functions, and provides protection for personal safety and protection for equipment and circuits through a dual protection mechanism, making the leakage protection device safer, more reliable and more widely used.

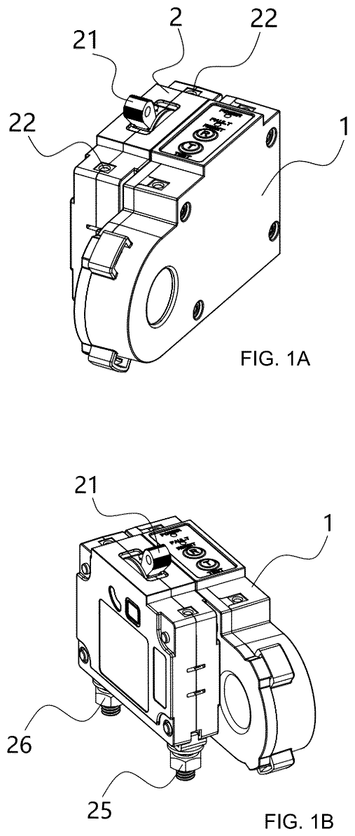

More specifically, referring to FIGS. 1A to 3B, a combined leakage protection device according to an embodiment of the present invention includes a ground fault circuit interrupter module 1 and a circuit breaker module 2. The circuit breaker module 2 includes an input end 25 and an output end 26, where the input end 25 is configured to be coupled to a power supply, and the output end 26 is configured to be coupled to an electrical load. The circuit breaker module 2 has an open state and a closed state, and has a circuit breaker assembly that can be operated to connect or disconnect the input end 25 and the output end 26. In the illustrated embodiment, the circuit breaker assembly may include an operating handle 21 and a circuit breaker tripping rod 23, wherein the operating handle 21 is configured to be able to move between its first position and second position, and drives the circuit breaker tripping rod 23 to move between its first position and second position. When the operating handle 21 is at its first position, the input end 25 and the output end 26 are in a disconnected state; when the operating handle 21 is moved from its first position to its second position, it drives the circuit breaker tripping rod 23 to move to its second position, so that the input end 25 and the output end 26 can be connected. Thereafter, according to the design of the embodiment, if the circuit breaker tripping rod 23 is in its first position, the input end 25 and the output end 26 of the circuit breaker module can be disconnected, and the operating handle 21 is restored to its first position at this time; even if the operating handle 21 is restricted in its second position due to special reasons, the input end 25 and the output end 26 can still be disconnected. When the circuit breaker tripping rod 23 is in its first position, even if the operating handle 21 is moved from its first position to its second position, the input end 25 and the output end 26 cannot be connected. These operations will be described in detail below.

Preferably, when the input end 25 and the output end 26 are in a connected (i.e. closed) state, the ground fault circuit interrupter module 1 can drive the circuit breaker tripping rod 23 to its first position to disconnect the input end 25 from the output end 26, which will be described in detail below. In addition, the circuit breaker module 2 also includes at least one mounting unit 22 for mounting and fixing the circuit breaker module 2 to a desired position or component. The mounting unit 22 includes, without limitation, screws, bolts, rails, etc., such as the panel bolts shown in the figure.

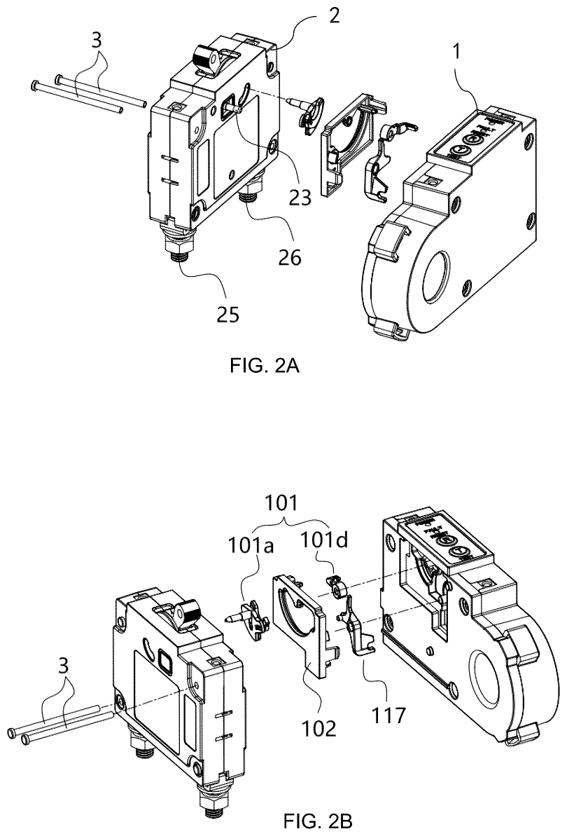

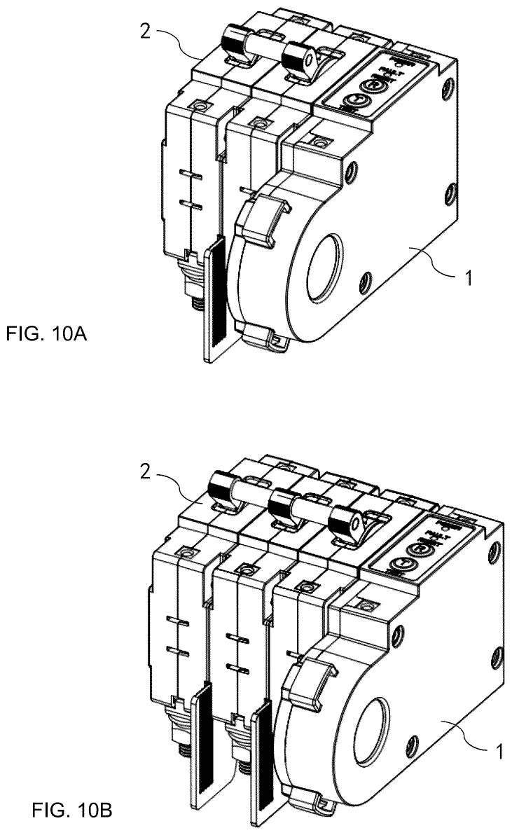

Depending on different needs, the combined leakage protection device according to this embodiment may include an at least one-pole circuit breaker module 2. For example, in the embodiments shown in FIGS. 1A to 3B, a one-pole circuit breaker module 2 and a ground fault circuit interrupter module 1 can be connected and relatively fixed to each other by a fixing device 3, such as shown in FIGS. 2A and 2B. The fixing device 3 includes, without limitation, for example, rivets, screws, snaps, connecting plates or fixing blocks and other suitable components. FIG. 10A exemplarily shows a leakage protection device including a two-pole circuit breaker module 2 and a ground fault circuit interrupter module 1. FIG. 10B exemplarily shows a leakage protection device including a three-pole circuit breaker module 2 and a ground fault circuit interrupter module 1. It should be understood that the number of circuit breaker modules is not limited here.

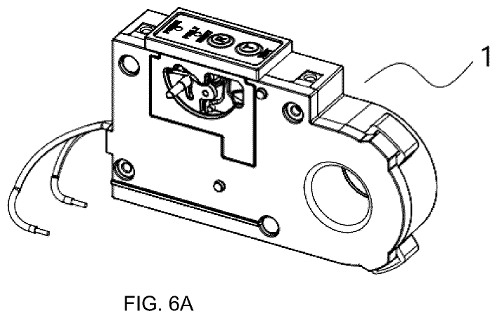

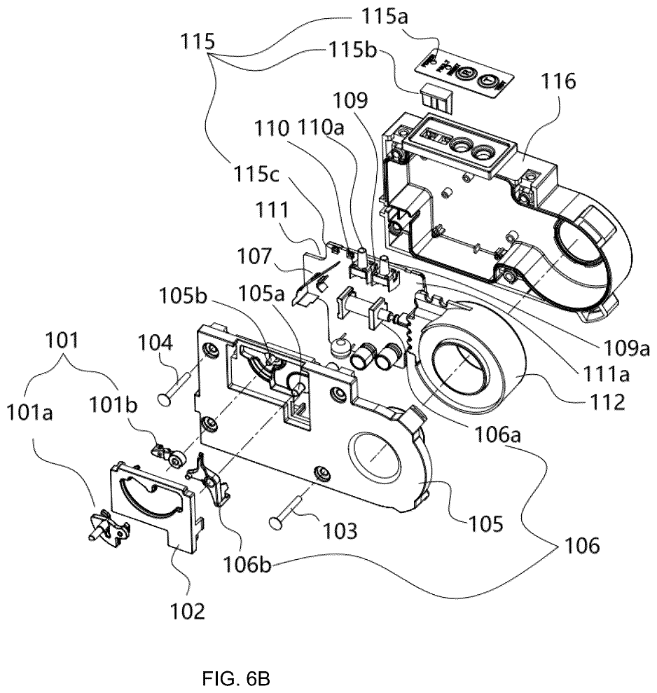

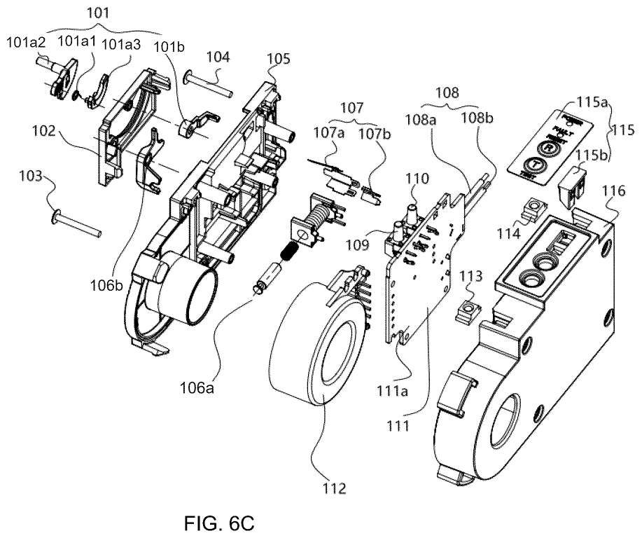

FIGS. 6A to 6C show a ground fault circuit interrupter module 1 and its main components according to an embodiment of the present invention. The ground fault circuit interrupter module 1 functions to detect a ground fault at the output end. When a ground fault is detected, it drives the circuit breaker tripping rod 23 of the circuit breaker module 2 to operate so that the power connection between the input end 25 and the output end 26 is disconnected.

Referring to FIGS. 6B and 6C, the ground fault circuit interrupter module 1 includes a housing, a ground fault signal processing unit 111 arranged in the housing, a drive assembly 106 coupled to the ground fault signal processing unit 111, and a locking device 101. The drive assembly 106 has a first position and a second position in response to the control of the ground fault signal processing unit 111. The locking device 101 can be attached to the circuit breaker module 2 and has a locked state and an unlocked state, and the locking device 101 can be mechanically linked with the drive assembly 106 to switch between the locked state and the unlocked state. Preferably, the ground fault circuit interrupter module 1 also includes an auxiliary switch 107 coupled to the ground fault signal processing unit 111, and the auxiliary switch 107 can be mechanically linked with the locking device 101 to be in an open state or a closed state. The drive assembly 106 includes a coil assembly 106a and an actuator 106b. The actuator 106b functions to drive the locking device 101 to its unlocked state. Preferably, the actuator 106b also functions to drive the circuit breaker module 2 to the open state. The coil assembly 106a is attached to the actuator 106b, and controls the actuator 106b to move in response to signals from the ground fault signal processing unit 111.

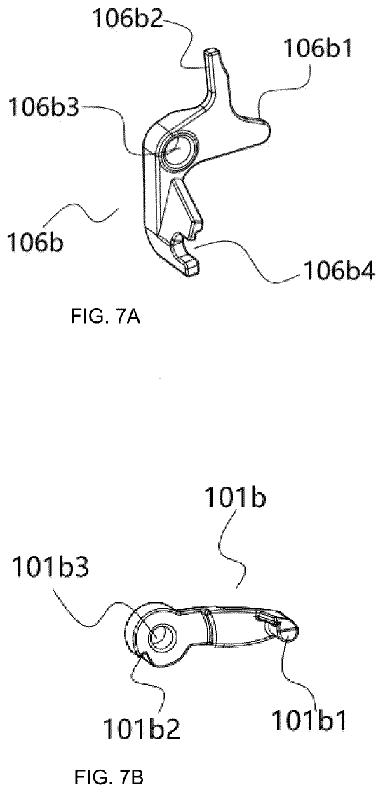

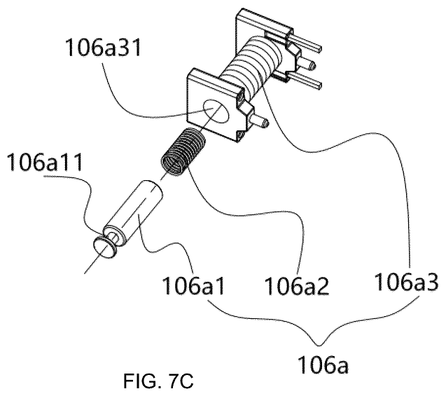

Specifically, as shown in FIG. 7A, the actuator 106b is provided with two tabs 106b1 and 106b2, where the tab 106b2 is configured to drive the circuit breaker tripping rod 23 to change the input end and the output end on the circuit breaker module from the closed state to the open state, and the tab 106b1 is configured to drive the locking device 101 to the unlocked state, thereby disconnecting the auxiliary switch 107. The ground fault signal processing unit 111 includes at least a control circuit board 111a and a ground fault signal detection unit 112, and the ground fault signal detection unit 112 includes at least one detection magnetic ring for detecting the ground fault signal in the output circuit passing through the detection magnetic ring. When the ground fault signal detection unit 112 detects the ground fault signal, the control circuit board 111a controls the coil assembly 106a to act, thereby driving the actuator 106b to act, which in turn drives the circuit breaker tripping rod 23 of the circuit breaker assembly to move to its first position, so that the input end and the output end are disconnected. Preferably, due to the mechanical linkage of the locking device 101 and the auxiliary switch 107, the auxiliary switch 107 is in a closed state before the input end 25 and the output end 26 are connected.

This way, in the combined leakage protection device according to embodiments of the present invention, through the coordinated actions of the locking device 101, the drive assembly 106 and the auxiliary switch 107, reliable and safe connection or disconnection between the input end 25 and the output end 26 can be realized. Specifically, when the input end 25 and the output end 26 need to be connected and the operating handle 21 is moved from its first position to its second position, the locking device 101 can drive the auxiliary switch 107 to be in a closed state first. At this time, if the ground fault signal detection unit 112 detects a ground fault signal, or the ground fault circuit interrupter module 1 is in a fault alarm state, the control circuit board 111a can directly control the coil assembly 106a to operate, thereby driving the actuator 106b to place the circuit breaker trip rod 23 in its first position. At this time, even if the operating handle 21 is moved continuously to its second position, the input end 25 and the output end 26 cannot be connected, thereby avoiding dangerous situations caused by incorrect operation. In particular, in certain embodiments, for example, when the movement of the operating handle 21 from the second position to the first position is limited, if the ground fault signal detection unit 112 detects a ground fault signal, the ground fault circuit interrupter module 1 can still control the actuator 106b to act, thereby driving the circuit breaker tripping rod 23 to disconnect the input end 25 and the output end 26 of the circuit breaker module 2, and at the same time putting the locking device 101 in an unlocked state to open the auxiliary switch 107. This avoids the problem of inability to disconnect the power when the operating handle 21 is obstructed, and improves the stability and reliability of the leakage protection device.

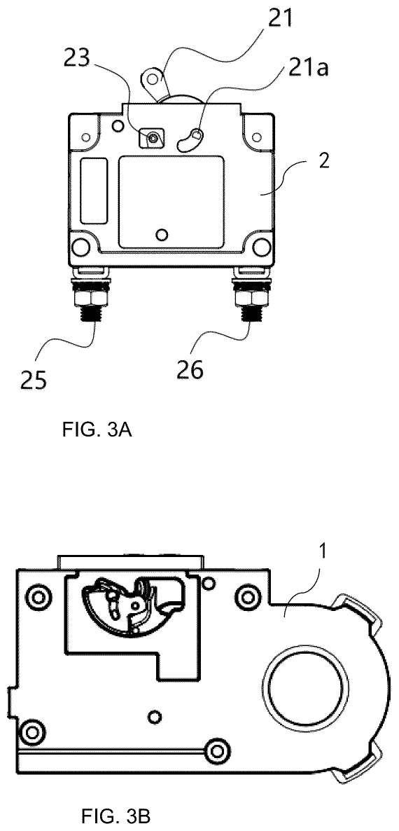

In the illustrated embodiment, the housing of the ground fault circuit interrupter module 1 includes at least an upper cover 105 and a base 116, which can be attached to each other by rivets 103, 104 and other similar components. An annular cavity may be provided at one end of the housing for accommodating the ground fault signal detection unit 112. The middle part of the housing is provided as a cavity to accommodate the movement components such as the ground fault signal processing unit 111, the drive assembly 106, the actuator 106b and the auxiliary switch 107. The housing is also provided with a through hole, which is concentric with the inner hole of the detection magnetic ring 112. In the illustrated embodiment, the housing can also include a cover plate 102, which is snapped on the upper cover 105 and combined with the upper cover 105 to form a housing space, which accommodates at least a part of the drive assembly 106 or the locking device 101. In some embodiments, the middle part of the cover plate 102 can be provided with an opening so that the ground fault circuit interrupter module 1 is attached to and mechanically linked with the circuit breaker module 2, as shown in FIGS. 3B and 6A to 6C.

As shown in FIG. 7C, the coil assembly 106a of the drive assembly 106 includes an iron core 106a1, an iron core spring 106a2, and a coil winding 106a3. The coil winding 106a3 can generate a magnetic field when energized and remove the magnetic field when de-energized in response to the control of the ground fault signal processing unit 111. The iron core 106al passes through the coil winding 106a3; one end of it is attached to the actuator 106b, and the other end abuts the iron core spring 106a2. The iron core 106al reciprocates in the center hole 106a31 of the coil winding 106a3 under the magnetic force of the coil winding 106a3 in response to its energized or de-energized state and the resilience of the iron core spring 106a2, thereby driving the actuator 106b to move. Specifically, the coil winding 106a3 is coupled to the ground fault signal processing unit 111 and is provided with a center hole 106a31 for the iron core 106al to be inserted. In addition, one end of the iron core 106al is provided with an iron core groove 106a11, and one end of the actuator 106b is correspondingly provided with a U-shaped groove 116b4 (see FIG. 7A) to engage with the iron core groove 106a11. This way, when the coil winding 106a3 is energized, a magnetic field is generated to drive the iron core 106al to move into the center hole 106a31, thereby driving the actuator 106b to move along with it. Conversely, when the coil winding 106a3 is de-energized and the magnetic field disappears, under the rebound force of the iron core spring 106a2, the iron core 106al and the actuator 106b return to their initial positions. Preferably, the actuator 106b is provided with a pivot hole 106b3, which is attached to the housing so that the actuator 106b can pivot, and the actuator 106b is configured to pivot around its pivot hole 106b3 with the movement of the iron core 106a1.

In some embodiments, the ground fault circuit interrupter module 1 further includes a fault reset unit 110. As shown in FIGS. 6B and 6C, the fault reset unit 110 includes an electronic component coupled to the ground fault signal processing unit 111 and a reset button 110a. At least one reset button hole is provided on the surface of the housing, and the reset button hole is used to allow a portion of the reset button 110a to pass through the housing.

In some embodiments, the ground fault circuit interrupter module 1 further includes a ground fault signal simulation unit 109. As shown in FIGS. 6B and 6C, the ground fault signal simulation unit 109 includes an electronic component coupled to the ground fault signal processing unit 111 and a test button 109a, which may be operated to simulate a leakage current to generate a ground fault signal. At least one test button hole is provided on the surface of the housing, and the test button hole is used to allow part of the test button 109a to pass through the housing.

In some embodiments, the ground fault circuit interrupter module 1 further includes a display unit 115. As shown in FIGS. 6B and 6C, at least one display hole is provided on the surface of the housing to allow the display signal of the display unit to pass through the housing. For example, the display unit 115 may include a panel 115a attached to the housing (e.g., the base 116) and a status indicator light 115c and a light guide column 115b coupled to the ground fault signal processing unit 111. When a ground fault occurs, an alarm display is provided by allowing a user to visually observe the status indicator light 115c through a display window on the panel 115a. When the fault is cleared, the alarm display can be cleared by pressing the reset button 110a. In some embodiments, the display unit 115 may include a light guide column 115b provided between the panel 115a and the status indicator light 115c. Preferably, the fault reset unit 110 is configured such that when the input end and the output end are in a disconnected state due to a ground fault or a simulated ground fault and the display unit 115 is in an alarm display state, causing the inability to connect the input end with the output end by moving the operating handle 21 to its second position again, it is necessary to operate the reset button 110a after the ground fault is eliminated to release the fault alarm state of the ground fault circuit interrupter module, and then move the operating handle 21 to its second position again, in order to connect the input end and the output end again.

The ground fault circuit interrupter module 1 further includes a power input unit 108, such as the wires 108a and 108b shown in FIG. 6C, for providing power to the ground fault signal processing unit 111. Depending on different needs, the power input unit may also be a connecting plates or a connecting terminal.

Similarly, the ground fault interrupter module 1 further comprises at least one mounting unit, such as the mounting units 113 and 114 shown in FIG. 6C, suitable for mounting the ground fault interrupter module 1 to a desired position or component. The mounting unit includes, without limitation, screws, bolts, rails, etc.

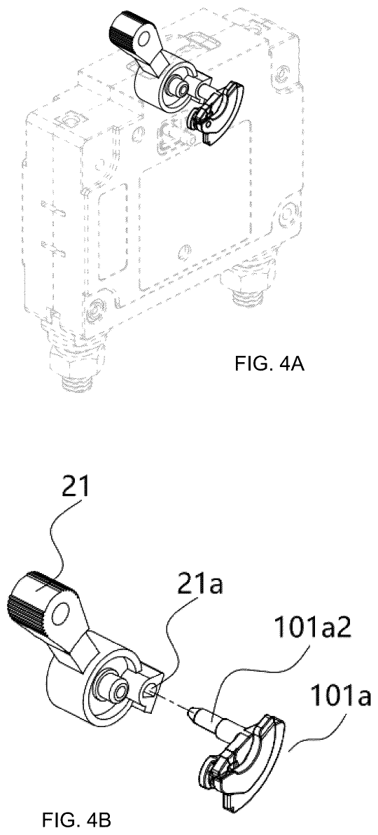

Referring to FIGS. 4A to 7B, in the illustrated embodiment, the locking device 101 includes a drive plate assembly 101a and a locking rod 101b attached to the operating handle 21. When the locking device 101 is in the locked state, during the process of the operating handle 21 moving between the first position and the second position, the locking device 101 is driven to close or open the auxiliary switch 107. Specifically, when the locking device 101 is in the locked state and the circuit breaker module 2 is in the closed state, the auxiliary switch 107 is in the closed state, and the locking device 101 can be driven by the actuator 106b to be in the unlocked state at any time during the driving process. The auxiliary switch 107 is configured to be in the closed state before the input end and the output end are connected.

In certain embodiments, as shown in FIGS. 4B to 7B, the locking device 101 includes a drive plate assembly and a locking rod 101b attached to the operating handle 21, where the locking rod 101b abuts against the auxiliary switch 107 to close the auxiliary switch. The drive plate assembly includes at least a driving plate 101a2 and a locking plate 101a3 pivotally connected to the driving plate 101a2. The driving plate 101a2 is mechanically linked with the circuit breaker module to define a first position and a second position, and the locking plate 101a3 is attached to the driving plate 101a2 and is moveable relative to the driving plate 101a2 between a first position and a second position. The drive assembly drives the locking plate 101a3 to move from its first position to its second position. When the locking plate 101a3 is in a first position relative to the driving plate 101a2, the driving plate assembly and the locking rod 101b are in a locked state, and the driving plate assembly can drive the locking rod 101b to move; when the locking plate 101a3 is in a second position relative to the driving plate 101a2, the driving plate assembly and the locking rod 101b are in an unlocked state, and the locking rod 101b can move independently relative to the driving plate assembly.

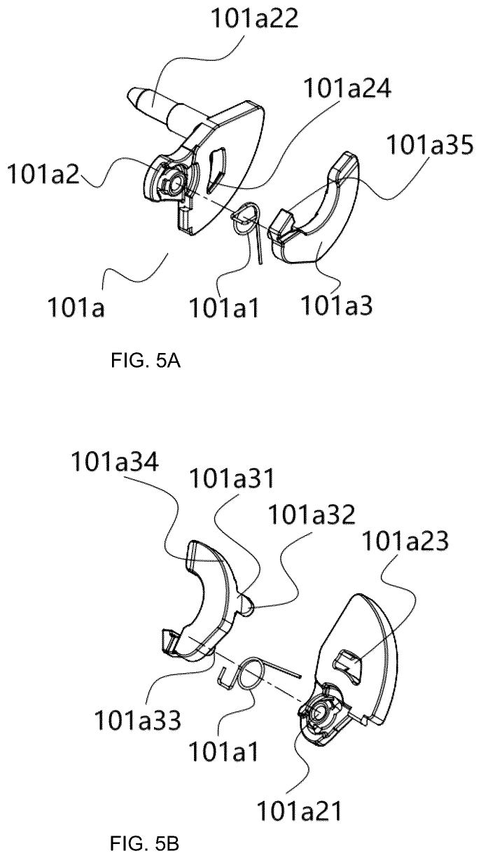

In some embodiments, the drive plate assembly further includes a resilient member disposed between the driving plate 101a2 and the locking plate 101a3 so as to urge the locking plate 101a3 to return from its second position to its first position. Preferably, the resilient member is a torsion spring 101al, for example, as shown in FIGS. 5A and 5B, where the torsion spring 101al is provided with a resilient winding and a first torsion spring leg and a second torsion spring leg. The driving plate 101a2 may be provided with a torsion spring hole buckle and a torsion spring leg buckle, the resilient winding of the torsion spring 101al may be snapped onto the torsion spring hole buckle of the driving plate 101a2, and the first torsion spring leg is snapped onto and fixed with the torsion spring leg buckle on the driving plate 101a2. Correspondingly, the locking plate 101a3 may be provided with a snap-fit end face, which abuts against the second torsion spring leg of the torsion spring 101al. Under the resilient force of the torsion spring 101al between the driving plate 101a2 and the locking plate 101a3, the locking plate 101a3 can be relatively fixed to the driving plate 101a2 while driving the locking rod 101b to move through pivoting motion.

The driving plate 101a2 may be attached to the operating handle 21 by a suitable means. For example, in the embodiments shown in FIGS. 4A to 5B, the operating handle 21 can be provided with a half-moon hole 21a, and the main body of the driving plate 101a2 can be configured as a fan-shaped panel, and a pin 101a22 with a corresponding half-moon cross-section is provided on one side of the fan-shaped panel, which is fitted in the half-moon hole 21a to achieve fixation with the operating handle 21 and in turn with the circuit breaker module 2, so that the driving plate 101a2 can move along with the movement of the operating handle 21. As shown in FIGS. 5A and 5B, the locking plate 101a3 is pivotally attached to the driving plate 101a2. The pivotal connection between the driving plate 101a2 and the locking plate 101a3 is achieved by providing a pivot hole 101a21 on the fan-shaped panel of the driving plate 101a2. A corresponding pivot 101a33 is provided at one end of the locking plate 101a3 and inserted into the pivot hole 101a21 so that it can pivot relative to the driving plate 101a2. The torsion spring 101al is sleeved on the pivot 101a33. In some embodiments, a position limiting slot 101a23 is provided on the fan-shaped panel of the driving plate 101a2, and a position limiting post 101a31 may be provided on the locking plate 101a3. When the locking plate 101a3 pivots relative to the driving plate 101a2, the position limiting post 101a31 moves along the position limiting slot 101a23 to limit the position limiting post 101a31 and further limit the movement range of the locking plate 101a3 on the driving plate 101a2. In some embodiments, the side wall of the position limiting slot 101a23 is also provided with a position limiting block 101a24, and the position limiting post 101a31 is provided with a position limiting hook 101a32. Under the action of the torsion spring force, the position limiting hook 101a32 can be hooked to the position limiting block 101a24 correspondingly provided in the position limiting slot 101a23 to limit the separation of the locking plate 101a3 and the driving plate 101a2, so that the locking plate 101a3 will not fall off the driving plate 101a2.

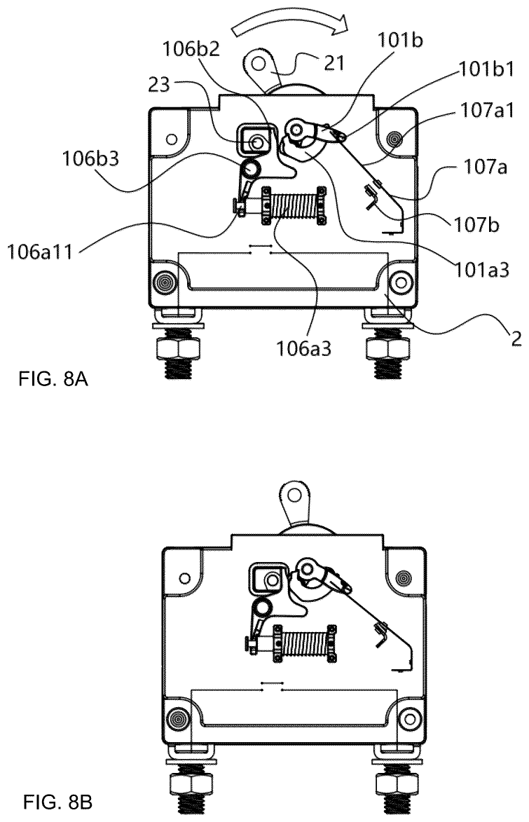

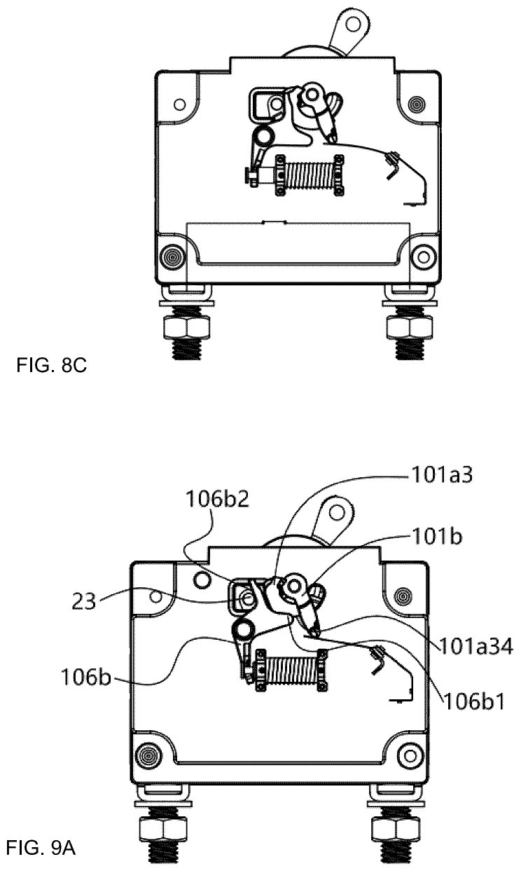

The matching relationship between the locking plate 101a3 and the locking rod 101b can be achieved by any appropriate means, so that the locking plate 101a3 can pivotally move while driving the locking rod 101b to move. In some embodiments, as shown in FIGS. 6B to 7B, the locking rod 101b is provided with a locking notch 101b2, and the locking plate 101a3 is provided with a locking protrusion 101a35 for either engaging the locking notch 101b2 and being in a locked state with the locking rod 101b or disengaging from the locking notch 101b2 and being in an unlocked state with the locking rod 101b. When in the locked state, as shown in FIG. 8A, the locking plate 101a3 and the locking rod 101b can move synchronously, that is, the pivoting movement of the locking plate 101a3 drives the locking rod 101b to move synchronously. This way, when the operating handle 21 of the circuit breaker module 2 is moved (e.g., pivoted), it drives the driving plate 101a2, the locking plate 101a3 and the locking rod 101b to move synchronously (e.g., pivoted), thereby closing the auxiliary switch 107. In other words, operating the operating handle 21 of the circuit breaker module 2 can drive the locking device 101 to close the auxiliary switch 107.

As described above, the housing of the ground fault circuit interrupter module 1 may include a cover plate 102 attached to the upper cover 105, and the locking rod 101b may be attached to the housing through a pivot hole 101b3, for example, positioned on a positioning column between the cover plate 102 and the upper cover 105 and capable of pivoting relative to the housing, where the positioning column may be formed on the cover plate 102 or the upper cover 105.

For the auxiliary switch 107, depending on different needs, a contact arm with contact terminals may be used to accomplish connection and disconnection. Other structures may alternatively be used. In the embodiments shown in FIGS. 6B to 7B and 8A, the auxiliary switch 107 includes a movable contact arm 107a and a stationary contact arm 107b respectively provided with contact terminals, and the locking rod 101b of the locking device 101 is provided with a driving column 101b1 configured to abut against the movable contact arm 107a. When the locking rod 101b is driven to pivot, the driving column 101b1 may exert a force to the resilient driving arm 107al of the movable contact arm 107a, thereby driving the movable contact arm 107a to contact the stationary contact arm 107b to close the auxiliary switch 107. When the locking device 101 is in the unlocked state, the auxiliary switch 107 is in the disconnected state, that is, after the locking rod 101b is unlocked, the locking rod 101b pivots in the opposite direction under the action of the rebound force of the resilient driving arm 107al of the moving contact arm 107a, and the moving contact arm 107a is separated from the static contact arm 107b, so that the auxiliary switch 107 is disconnected.

Depending on different needs, the actuator 106b may be constructed in any suitable form that can drive the circuit breaker tripping rod 23 to achieve disconnection between the input end and the output end. As described above, the actuator 106b is configured to pivot around the pivot with the movement of the iron core 106a1. In some embodiments, the actuator 106b may be positioned on the positioning column between the cover plate 102 and the upper cover 105 through the pivot hole 106b3 and can pivot relative to the housing driven by the iron core. The positioning column may be formed on the cover plate 102 or the upper cover 105.

In the embodiment shown in FIG. 7A, as described above, in addition to the annular groove 106b4 that is snap-fitted with the iron core groove 106a11 of the iron core 106a1, the actuator 106b is provided with a support tab for abutting against the locking device and a support tab for abutting against the circuit breaker assembly. Specifically, referring to FIGS. 5B and 7A, the actuator 106b is provided with a support tab 106b1 for abutting against the locking plate 101a3, and the locking plate 101a3 is correspondingly provided with a contact surface 101a34. The actuator 106b is also provided with a support tab 116b2 for abutting against the circuit breaker tripping rod 23.

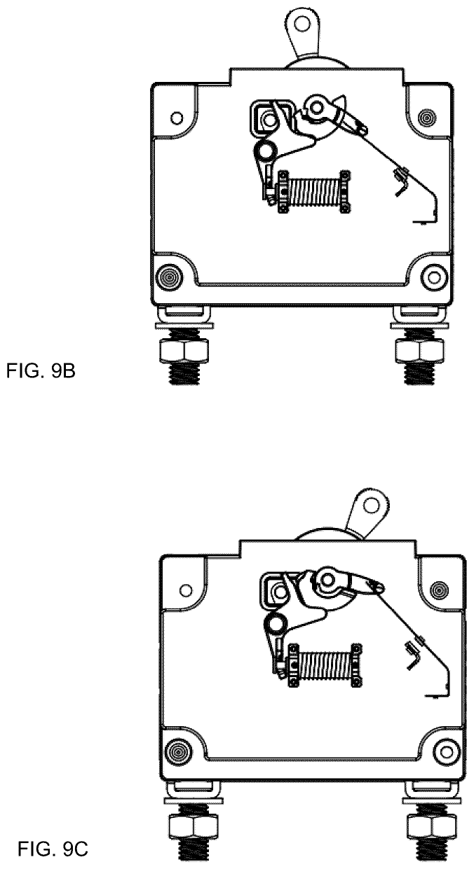

The operation of the combined leakage protection device according to embodiments of the present invention and the protection functions that can be achieved are described below with reference to FIGS. 8A to 9C.

First, refer to FIG. 8A, which shows the operating handle 21 in the first position, and the input and output ends are in the disconnected state. When the operating handle 21 moves (rotates) from the first position to the second position along the direction of the arrow to cause the driving plate 101a2 to pivot and in turn drive the locking plate 101a3 to rotate, the contact surface 101a34 of the locking plate 101a3 approaches the support tab 106b1 of the actuator 106b, and the locking plate 101a3 and the locking rod 101b are in the locked state and drive the locking rod 101b to rotate. In turn, the driving column 101b1 exerts a force on the resilient driving arm 107al of the moving contact arm 107a to close the auxiliary switch 107. As shown in FIG. 8B, at this time, the input and output ends of the circuit breaker module 2 are not yet connected.

There are two scenarios in the state shown in FIG. 8B. First scenario: If the ground fault signal processing unit 111 does not detect a ground fault signal or a simulated ground fault signal, when the operating handle 21 is successfully moved to its second position, it brings the circuit breaker tripping rod 23 to its second position, and the input and output ends of the circuit breaker module are successfully connected, as shown in FIG. 8C. Second scenario: If the ground fault signal processing unit 111 has detected a ground fault signal and sent an action signal, then when the auxiliary switch 107 is closed, the coil winding 106a3 is energized and generates a magnetic field to drive the iron core 106al to drive the actuator 106b to pivot synchronously, until the tab 106b2 of the actuator 106b abuts against the circuit breaker tripping rod 23 and drives the circuit breaker tripping rod 23 to move to its first position, preventing the input and output ends of the circuit breaker module 2 from being connected. Thus, even if the operating handle 21 is moved to its second position, the input and output ends cannot be connected. At the same time, when the actuator 106b rotates, the tab 116bl contacts the contact surface 101a34 of the locking plate 101a3, driving the lock plate 101a3 to rotate and disengage from the locking notch 101b2 of the locking rod 101b and to be in an unlocked state with the locking rod 101b. The locking rod 101b pivots back to the initial position under the rebound force of the resilient driving arm 107al. At the same time, under the rebound force of the resilient driving arm 107al, the moving contact arm 107a and the stationary contact arm 107b separate from each other, so that the auxiliary switch 107 is disconnected, as shown in FIG. 9C.

As shown in FIG. 9A, when the operating handle of the circuit breaker module 2 is located in its second position and the input and output ends are connected and the device is working normally, if the ground fault signal detection unit 112 detects a ground fault signal, it feeds the signal to the ground fault signal processing unit 111. The ground fault signal processing unit 111 compares the signal to preset parameters. When the signal is smaller than the preset parameters, the signal processing unit 111 does not control the drive assembly 106 to act, and when it is greater than the set parameters, the signal processing unit 111 controls the drive assembly 106 to act. Specifically, the iron core 106a1 of the drive assembly 106 is driven by the magnetic force to drive the actuator 106b to act, and the actuator 106b in turn pivots and drives the circuit breaker trip rod 23 to act through the tab 106b2, so that the circuit breaker module 2 disconnects the power connection between the output end and the input end. At the same time, when the actuator 106b rotates, the tab 106b1 contacts with the contact surface 101a34 of the locking plate 101a3, driving the locking plate 101a3 to pivot and disengage from the locking notch 101b2 of the locking rod 101b and to be in an unlocked state with the locking rod 101b. Under the action of the rebound force of the resilient driving arm 107a1, the locking rod 101b pivots from the state shown in FIG. 9A to the state shown in FIG. 9B and returns to the initial position. At the same time, under the action of the rebound force of the resilient driving arm 107a1, the moving contact arm 107a and the stationary contact arm 107b separate from each other, so that the auxiliary switch 107 is disconnected, as shown in FIG. 9C.

As shown in FIG. 9A, when the operating handle of the circuit breaker module 2 is in its second position and the input and output ends are connected and the device is working normally, if the test button 109a is pressed, the ground fault signal simulation unit 109 generates a simulated ground fault signal greater than a preset parameter, and feed the signal to the ground fault signal processing unit 111, which compares the preset parameter with signal and controls the drive assembly 106 to act accordingly. Similarly, when the drive assembly 106 acts, it drives the actuator 106b to act, and the actuator 106b in turn drives the circuit breaker tripping rod 23 to act, so that the circuit breaker module 2 disconnects the power connection between the output end and the input end. At the same time, the actuator 106b drives the locking plate 101a3 and the locking rod 101b to be in the unlocked state, so that the locking rod 101b pivots from the state shown in FIG. 9A to the state shown in FIG. 9B and returns to the initial position under the action of the rebound force of the resilient driving arm 107al. At the same time, under the action of the rebound force of the resilient driving arm 107a1, the moving contact arm 107a and the stationary contact arm 107b separate from each other, so that the auxiliary switch 107 is disconnected, as shown in FIG. 9C.

In some conditions, when the operating handle 21 is in its second position, it cannot move freely due to external reasons. As shown in FIG. 9A, the operating handle of the circuit breaker module 2 is in its second position and the input and output ends are connected and the device is working normally. Due to external reasons, the operating handle is restricted and cannot move from the second position to the first position. If the ground fault signal detection unit detects a ground fault signal or if the test button 109a is pressed, the ground fault circuit interrupter module 1 can still drive the actuator 106b to operate through the driving assembly 106, which in turn drives the circuit breaker tripping rod 23 to its first position, so that the input and output ends of the circuit breaker module 2 are disconnected, and the auxiliary switch 107 inside the ground fault circuit interrupter module 1 is in the disconnected state.

After the circuit breaker module 2 disconnects the power connection between the input and output ends due to the ground fault signal detection unit detecting a ground fault signal or the test button 109a being pressed, if the power connection between the input and output ends is to be reconnected, the ground fault must first be eliminated and the ground fault alarm state be cleared by operating the fault reset unit 110. Thereafter, the operating handle 21 of the circuit breaker module 2 can be operated to connect the power connection between the input and output ends. This way, the leakage protection device according to embodiments of the present invention can timely cut off the power to protect the safety of people and equipment when a leakage fault occurs, and is suitable for a variety of electrical equipment and can be used in various occasions.

It should be understood that the embodiments shown in the drawings only illustrate the preferred shapes, sizes and spatial arrangements of the various components of the leakage current protection device. These illustrations do not limit the scope of the invention; other shapes, sizes and spatial arrangements may be used without departing from the spirit of the invention.

It will be apparent to those skilled in the art that various modification and variations can be made in the embodiments of the present invention without departing from the spirit or scope of the invention. Thus, it is intended that the present invention cover modifications and variations that come within the scope of the appended claims and their equivalents.

1. A combined leakage protection device comprising:
an input end, configured to be coupled to a power supply;
an output end, configured to be coupled to an electrical load;
a circuit breaker module, having a disconnected state and a connected state, which respectively disconnects and connects an electrical connection between the input end and the output end; and
a ground fault circuit interrupter module, including a housing, a ground fault signal processing unit, and a drive assembly and a locking device couple to the ground fault signal processing unit, disposed inside the housing;
wherein the drive assembly is in a first position or a second position under control of the ground fault signal processing unit; and
wherein the locking device is attached to the circuit breaker module and has a locked state and an unlocked state, wherein the locking device is mechanically linked to the drive assembly to switch between the locked state and the unlocked state.

2. The combined leakage protection device of claim 1, wherein the locking device includes a drive plate assembly and locking rod attached to the circuit breaker module.

3. The combined leakage protection device of claim 2, wherein the drive plate assembly includes a driving plate and a locking plate.

4. The combined leakage protection device of claim 3, wherein the driving plate is attached to the circuit breaker module and mechanically linked to the circuit breaker module to define a first position and a second position of the driving plate; and
wherein the locking plate is attached to the driving plate and is moveable relative to the driving plate between a first position and a second position of the locking plate.

5. The combined leakage protection device of claim 4, wherein when the locking plate is at its first position relative to the driving plate, the drive plate assembly and the locking rod are in a locked state and the locking rod is driven by the drive plate assembly; and
when the locking plate is at its second position relative to the driving plate, the drive plate assembly and the locking rod are in an unlocked state and the locking rod is independently moveable relative to the drive plate assembly.

6. The combined leakage protection device of claim 4, wherein the drive plate assembly further includes a resilient member disposed between the driving plate and the locking plate and configured to urge the locking plate to return from its second position to its first position.

7. The combined leakage protection device of claim 6, wherein the resilient member is a torsion spring which has a resilient winding, a first torsion spring leg and a second torsion spring leg.

8. The combined leakage protection device of claim 3, wherein the driving plate has a main body which is a fan-shaped panel, and a pin formed on one side of the fan-shaped panel, wherein the driving plate is attached to the circuit breaker module via the pin.

9. The combined leakage protection device of claim 8, wherein the fan-shaped panel of the driving plate defines a pivot hole and a position limiting slot.

10. The combined leakage protection device of claim 9, wherein the position limiting slot defines a position limiting block on its side wall.

11. The combined leakage protection device of claim 7, wherein the driving plate further includes a torsion spring hole buckle and a torsion spring leg buckle, wherein the resilient winding of the torsion spring is snapped onto the torsion spring hole buckle and the first torsion spring leg is snapped onto and fixed with the torsion spring leg buckle.

12. The combined leakage protection device of claim 11, wherein the locking plate includes a snap-fit end face which abuts against the second torsion spring leg of the torsion spring.

13. The combined leakage protection device of claim 3, wherein the locking plate is attached to the driving plate, and wherein the locking plate includes a pivot at one end and is configured to pivot relative to the driving plate.

14. The combined leakage protection device of claim 13, wherein the locking plate further includes a position limiting post configured to limit a movement range of the locking plate on the driving plate.

15. The combined leakage protection device of claim 14, wherein the position limiting post includes a position limiting hook configured to prevent separation of the locking plate and the driving plate.

16. The combined leakage protection device of claim 3, wherein the locking plate further includes a locking protrusion configured to drive the locking rod to move.

17. The combined leakage protection device of claim 4, wherein the drive assembly is configured to drive the locking plate to move from its first position to its second position.

18. The combined leakage protection device of claim 2, wherein the locking rod has a pivot hole, which is attached to the housing to allow the locking rod to pivot relative to the housing.

19. The combined leakage protection device of claim 2, wherein the locking rod has a locking notch, wherein the drive plate assembly is configured to drive the locking rod by engaging the locking notch.

20. The combined leakage protection device of claim 1, wherein the drive assembly includes:
an actuator, configured to drive the locking device to an unlocked state; and
a coil assembly, attached to the actuator, and configured to control movement of the actuator in response to the ground fault signal processing unit.

21. The combined leakage protection device of claim 20, wherein the coil assembly includes a coil winding, an iron core, and an iron core spring.

22. The combined leakage protection device of claim 20, wherein the actuator is configured to drive the circuit breaker module to the disconnected state.

23. The combined leakage protection device of claim 20, wherein the actuator has a pivot hole attached to the housing, wherein the actuator is configured to pivot relative to the housing.

24. The combined leakage protection device of claim 21, wherein the coil winding has a center hole configured to accommodate the iron core spring and the iron core.

25. The combined leakage protection device of claim 24, wherein the coil winding drives the iron core to reciprocate in the center hole in response to the ground fault signal processing unit.

26. The combined leakage protection device of claim 21, wherein the iron core has an iron core groove, configured to engage with the actuator to drive the actuator to move.

27. The combined leakage protection device of claim 1, wherein the ground fault circuit interrupter module further includes an auxiliary switch coupled to the ground fault signal processing unit, wherein the auxiliary switch is mechanically linked to and moves with the locking device to be in an open state or a closed state.

28. The combined leakage protection device of claim 27, wherein the auxiliary switch includes a resilient driving arm configured to contact the locking device.

29. The combined leakage protection device of claim 27, wherein when the locking device is in the unlocked state, the auxiliary switch is in the open state.

30. The combined leakage protection device of claim 27, wherein when the locking device is in the locked state and the circuit breaker module is in the closed state, the auxiliary switch is in the closed state.

31. The combined leakage protection device of claim 1, wherein the housing of the ground fault circuit interrupter module includes upper cover and a base, which form a cavity to accommodate the ground fault signal detection unit and the drive assembly coupled to the ground fault signal detection unit.

32. The combined leakage protection device of claim 31,
wherein the ground fault signal processing unit includes a detection magnetic ring configured to detect a ground fault signal in an electrical circuit passing through the detection magnetic ring; and
wherein the housing has a through hole concentric with an inner hole of the detection magnetic ring.

33. The combined leakage protection device of claim 31, wherein the housing further includes a cover plate, which is snapped on the upper cover and form a housing space with the upper cover, wherein the housing space accommodates at least a part of the drive assembly or the locking device.

34. The combined leakage protection device of claim 33, wherein the cover plate has an opening in a middle part to allow the ground fault circuit interrupter module to be attached to and mechanically linked with the circuit breaker module.

35. The combined leakage protection device of claim 1, wherein the housing includes a test button hole,
wherein the ground fault signal processing unit includes a test button; and
wherein a portion of the test button passes through the housing via the test button hole.

36. The combined leakage protection device of claim 1, wherein the housing includes a reset button hole,
wherein the ground fault signal processing unit includes a reset button; and
wherein a portion of the reset button passes through the housing via the reset button hole.

37. The combined leakage protection device of claim 1, wherein the housing includes a display hole,
wherein the ground fault signal processing unit includes a display unit; and
wherein a display signal of the display unit passes through the housing via the display hole.

38. The combined leakage protection device of claim 1, further comprising a fixing device configured to connect the circuit breaker module and the ground fault circuit interrupter module to each other.

39. The combined leakage protection device of claim 38, wherein the fixing device includes at least one of a rivet, a screw, and a snap.
